(19) United States
(12) Patent Application Publication
(10) Pub. No.: US 2026/0004437 A1
(43) Pub. Date: Jan. 1, 2026

(54) METHOD FOR DETERMINING THE SPEED OF A TRACK-GUIDED VEHICLE TRAVELING ON A ROUTE, VEHICLE, COMPUTER PROGRAM PRODUCT AND COMPUTER-READABLE STORAGE MEDIUM

(71) Applicant: Siemens Mobility GmbH, München (DE)

(72) Inventors: Arne Muxfeldt, Braunschweig (DE); Tomasz Bluszcz, Braunschweig (DE); Martin Schürmann, Braunschweig (DE); Karsten Rahn, Cremlingen (DE)

(21) Appl. No.: 19/254,300

(22) Filed: Jun. 30, 2025

(30) Foreign Application Priority Data
Jun. 28, 2024 (EP) 24185476.9

(51) Int. Cl. G06T 7/246; G06T 7/73

(52) U.S. Cl. CPC G06T 7/248; G06T 7/74; G06T 2207/10016; G06T 2207/30252

(57) ABSTRACT

A method for determining the speed of a track-guided vehicle traveling on a route includes capturing and storing a sequence of images of the route and its environment using an imaging sensor, and storing respective capture times of the images such that they are assigned to the respective images. Characteristic image areas are then recognized in the images, wherein a number of stored images is selected in order to ascertain a perspective displacement of at least one characteristic image area in the selected number of images, which arises due to movement of the vehicle. The perspective displacement can then be converted into a speed taking into account the capture times of the selected number of images. A vehicle with a facility for determining speed is also provided. Comparatively accurate relative localization of the vehicle can be performed if absolute localization of the vehicle is not possible at the time.

### CROSS-REFERENCE TO RELATED APPLICATION

This application claims the priority, under 35 U.S.C. § 119, of European Patent Application EP 24185476.9, filed Jun. 28, 2024; the prior application is herewith incorporated by reference in its entirety.

### FIELD OF THE INVENTION

The invention relates to a method for determining the speed of a track-guided vehicle traveling on a route. Furthermore, the invention relates to a vehicle with a facility for determining speed. Furthermore, the invention relates to a computer program product containing program instructions. Furthermore, the invention relates to a computer-readable storage medium containing data.

### BACKGROUND OF THE INVENTION

The prior art relates to the use of comparatively complex odometry based on, for example, balises, radar systems, GPS and odometers. Therein, absolute localization is carried out by the balises and/or GPS. Relative updating of localization (relative localization) is, for example, carried out by radar systems and odometers, namely by measuring the speed of the vehicle based on the last known location ascertained by absolute localization and updating the location of the vehicle with knowledge of the course of the route on the basis of the measured speed. That results in follow-up errors. Hence, localization is relatively accurate when absolute localization is possible and becomes more uncertain when localization is only based on relative updating, wherein the longer the relative localization takes, the greater the follow-up error.

Safe operation of trains also requires trains to know their position (location) and the speed at which they are traveling. That is required, inter alia, to determine and monitor braking curves and safety distances. The location can be obtained comparatively accurately by localization using functional components on the route, such as balises or recognized landmarks (e.g. object recognition) or by using navigation satellites. That will be referred to below as absolute localization. In that case, measuring errors are primarily dependent on the measuring accuracy of the method and are independent of the duration of the measurement.

However, the aforementioned localization methods are not permanently available. For that reason, measurement methods are implemented on the vehicle that can determine the location based on the last known location using a method for absolute localization and the vehicle's speed profile. That will be referred to below as relative localization. The speed information for relative localization must be as precise as possible and as independent as possible from wheel slip that influences the known odometry (using tachometers). In that case, the uncertainty of the ascertained location (also referred to as the cumulative measuring error) increases with the duration of the measurement. To date, therefore, that object has been achieved in an odometry component, for example by using signals from odometer pulse generators and slip-independent radar sensors and merging them with the aid of sensor error models to obtain a reliable speed. However, that solution is complex and is therefore associated with high costs.

U.S. Publication No. 2016/0121912 A1 describes how a track-guided vehicle can also be localized by recognizing objects located on the route. Once those objects have been recognized, their position, which is, for example, stored in a database, is used as location information.

U.S. Publication No. 2017/0327138 A1 describes a method with which object recognition for track-guided vehicles can be trained by using artificial intelligence (hereinafter AI), wherein reinforcement learning (hereinafter RL) is used. RL is a machine learning (ML) technique that trains software to make decisions in order to achieve optimal results. It mimics the trial-and-error learning process that humans use to achieve their goals. Once a detection process has been learned or trained, it can be used to localize the track-guided vehicle. A distinction must therefore be made between a learning phase of the system in which the system is not yet available and an application phase of the system in which localization can take place with the aid of object recognition.

European Patent Application EP 4067202 A1 discloses a method with which track-guided vehicles can be localized in a vehicle depot. That is done using cameras that recognize defined location markers in the depot in images having a position which is known. That is particularly easy to perform in depots since they are usually located in areas that are closed off from the outside, which means there is very little influence on the location markers (for example due to external influences such as vandalism) and the method can therefore be applied reliably.

The problem arising from the above-described prior art is that methods for ascertaining speed should generate as little cumulative error as possible, even with relative localization, and the implementation of the method should be as cost-effective as possible.

International Publication WO 2007/091072 A1 describes a system for determining the speed and position of a train or a similar vehicle. It includes an image capture device that is mounted on the train so it can capture a sequence of images of the environment ahead of or behind the train, and an image processor for processing the images captured by the image capture device. The image processor processes the image sequence and derives the speed of the train from the apparent motion of objects in the images. It also recognizes trackside markers, each of which uniquely identifies its position, thus deriving the position of the train from the identity of the marker.

International Publication WO 2019/068699 A1 relates to a driver assistance system, a motor vehicle and a method for classifying at least one object point of an object in an environment of a motor vehicle, wherein an image sequence of images is captured by using at least one imaging sensor facility of the motor vehicle, and the images capture at least one part of the environment of the motor vehicle with the object point. Moreover, at least for the case that an entrinsic motion of the motor vehicle relative to the environment fulfils a predetermined criterion, an epipolar plane is ascertained with regard to a first image of the image sequence recorded at a first point in time and a second image of the image sequence recorded at a second point in time, wherein a first vector pointing from a position of the sensor facility at the second point of time in the direction of the object point is ascertained on the basis of the second image and the at least one object point is classified as static or dynamic in dependence on a relative position of the first vector to the epipolar plane.

### SUMMARY OF THE INVENTION

It is accordingly an object of the invention to provide a method for determining the speed of a track-guided vehicle traveling on a route, a vehicle, as well as a computer program product and a computer-readable storage medium with which the improved method can be performed, which overcome the hereinafore-mentioned disadvantages and resolve the problems of the heretofore-known methods, vehicles, computer program products and computer-readable storage media of this general type, which are cost-effective, which can operate with the highest possible measuring accuracy even during extended operating times and which can permanently meet the stringent safety requirements applicable to rail transport.

With the foregoing and other objects in view there is provided, in accordance with a first aspect of the invention, a method for determining the speed of a track-guided vehicle traveling on a route, in which:
a) a sequence of images of the route and its environment is captured and stored by an imaging sensor,
b) respective capture times of the images are stored in such a way that they are assigned to the respective images,
c) characteristic image areas are recognized in the images.

When imaging sensors are referred to in the context of this description of the invention, the measurement result of the sensor or the processing of this measurement result by data processing is image information. This image information represents the measurement result two-dimensionally on an image surface. Herein, the image information can be digital, preferably in the form of a matrix of image points, or analog.

Characteristic image areas are image areas that can also be recognized repeatedly in a sequence of images that change quasi-continuously (i.e. stepwise) due to the movement of the vehicle. Characteristic image areas can, for example, be characterized by abrupt changes in contrast or color and can be recognized in the images in a known computer-aided manner. Herein, it is not necessary to recognize specific objects in the images—but object recognition can be performed optionally. In this case, the recognized objects limit the characteristic image areas.

An apparatus is computer-aided or computer-implemented if it has a computing environment or a method is computer-aided or computer-implemented if a computing environment executes at least one method step of the method.

A computing environment is an IT infrastructure formed of functional components such as processors, memory units, programs and data to be processed with the programs, which are used to execute at least one application that has to carry out a task. Further functional components can be formed of sensors and actuators that enable the computing environment to interact with the outside world. The IT infrastructure can also be organized as a network of the functional components.

A cloud (also referred to as a computer cloud or data cloud) is a computing environment for so-called cloud computing. This refers to an IT infrastructure that is made available via network interfaces such as the internet. It usually includes storage space, computing power or software as a service, without these having to be installed on the computing entity using the cloud. The services offered in the context of cloud computing cover the entire spectrum of information technology and, inter alia, include the IT infrastructure, platforms, software and computing power, wherein the cloud provider distributes the resources offered to cloud users as required with the aim of making optimum use of the resources.

As high safety standards apply in railroad technology with regard to the function (operational reliability, safety) and vulnerability (transmission reliability, security) of computer-implemented solutions, the functionalities of a cloud used in railroad technology, are usually limited in terms of their shared availability. Therefore, restrictions are necessary, in particular with regard to access by a potentially unlimited number of cloud users. However, access must also be limited with regard to the sharing of computing resources by different computing entities in order to ensure the necessary redundancy. In the context of this invention, technology that takes account of these restrictions in particular with regard to railroads is also referred to as a private cloud, even if a private cloud only fulfils the technical features associated with cloud technology to a limited extent.

Computing entities form functional units within a computing environment that can be assigned to applications (provided, for example, by a number of program modules) and can execute them. When executing the application, these functional units form physically (for example computer, processor) and/or virtually (for example program module) self-contained systems.

Computers are electronic devices with data processing capabilities formed of a plurality of functional components. Computers can, for example, be clients, servers, handheld computers, communication devices and other electronic devices for data processing, which can have processors and storage units and can also be connected to a network via interfaces.

Processors can, for example, be converters, sensors for generating measurement signals or electronic circuits. A processor can be a central processing unit (CPU), a microprocessor, a microcontroller or a digital signal processor, possibly in combination with a storage unit for storing program instructions and data. A processor can also be a virtualized processor or a soft CPU.

Storage units can be configured on a computer-readable memory in the form of random-access memory (RAM) or data storage (hard disk or data carrier).

Program modules are individual software functional units that enable a program sequence of method steps according to the invention. These software functional units can be implemented in a single computer program or in a plurality of computer programs communicating with one another. The interfaces realized in this case can be implemented at software level within a single processor or at hardware level if a plurality of processors is used.

Interfaces can be realized at hardware level, for example a wired or wireless connection, or at software level, for example as an interaction between individual program modules of one or more computer programs and are used to exchange data, preferably in the form of digital data records or analog signals.

In order to avoid misunderstandings, it should be noted at this point that individual claim features are numbered consecutively using lowercase Latin letters without taking the claim numbering into account. This means that each letter only appears once in the entire set of claims, which makes it possible to clearly address the claim features concerned without mentioning the claim number. For this reason, however, the order of the letters is of no significance.

According to the invention, it is provided that
d) a number of stored images is selected,
e) a perspective displacement of at least one characteristic image area in the selected number of images, which arises due to the movement of the vehicle, is ascertained,
f) the perspective displacement is converted into a speed taking into account the capture times of the selected number of images.

The invention solves the problem by deriving the speed information from the temporal sequence of recorded images. This is explained below by way of example. According to the invention, at least two images are to be recorded at a known time interval. These images must at least partially show the same image content and are recorded by the same imaging sensor, which is preferably aligned in the direction of travel.

Algorithms such as Harris Corner, SIFT (scale invariant feature transform), SURF (speeded up robust feature), FAST (features from accelerated segment test) or ORB (oriented FAST and rotated BRIEF), which are known per se, can be used to determine characteristic image areas, also known as feature points, in the images, which are preferably invariant, for example under different lighting conditions.

If the location where the vehicle was last located and the time at which the vehicle was located at this location are known, the temporal profile of the speed can be used in the context of the relative localization in order to determine the current location of the vehicle. In particular, this determination takes place on the route (this is one-dimensional localization with reference to the course of the route, depicted, for example, in a preferably digital route atlas). If the course of the route is known in a two-dimensional map, the location on the route can simultaneously be used to determine the location in this two-dimensional preferably digital map. The localization method itself is already known per se using odometric methods (for example tachometers). However, this advantageously has a higher level of accuracy when the method according to the invention is used. Herein, cameras, for example, are inexpensive to purchase and operate as imaging sensors, which advantageously increases the cost-effectiveness of the method.

Alignment in the direction of travel makes it possible to track the perspective change of feature points as the vehicle approaches them, causing them to increase in size and move to the side of the image. As soon as a feature point is recognized, its tracking is advantageously simplified by the fact that the feature point becomes increasingly larger in the image. It is also advantageous that the closer the feature point is to the camera, the better its resolution and the more accurately it can be calculated. This improves the quality with which it describes the train movement. Of course, it is also possible to align the imaging sensor against the direction of travel, i.e. at the end of the vehicle, wherein the method is reversed (feature points move toward the center of the image and become smaller as they do so).

In other words, the invention describes a method for ascertaining the speed on the basis of a temporal sequence of camera images and the evaluation of feature points. Due to the optical measurement method, the ascertained speed is independent of sliding or skidding processes in the wheel-rail contact and, due to this property, is very valuable for odometry. One advantage is that the feature points are selected by an algorithm. This does not require objects to be recognized and tracked in the image. Hence, the method can be used without route-specific training or adaptation to different environments with different optical characteristics.

With the objects of the invention in view, there is also provided, as a further aspect of the invention, a vehicle with a facility for determining speed having a sensor and a computing entity. According to this aspect, it is provided according to the invention that:
g) the sensor is embodied as an imaging sensor and is configured to perform at least method step a) according to the invention,
h) the at least one computing entity is part of a computing environment, wherein the computing environment is configured to perform at least method steps b), c), d), e), and f) according to the invention. The advantages associated with this aspect of the invention have already been explained above and reference is hereby made to these advantages.

With the objects of the invention in view, there is furthermore provided, as a further aspect of the invention, a computer program product containing program instructions which can be executed by a computing environment. According to this aspect, it is provided according to the invention that at least steps b), c), d), e), and f) of the method are executed.

Hence, according to the invention, a computer program product containing program instructions is described, wherein the program module can run in the same computing entity or in a plurality of computing entities of the computing environment. The computer program product, which can include a computer program or a plurality of computer programs, can in each case be used to execute the method according to the invention and/or the exemplary embodiments thereof and the above-described advantages are achieved with the execution.

With the objects of the invention in view, there is concomitantly provided, as a further aspect of the invention, a computer-readable storage medium containing data stored as data records by the storage medium. According to this aspect, it is provided according to the invention that the data records render the above-described computer program product according to the last preceding two paragraphs executable.

Hence, furthermore, a providing apparatus for storing and/or providing the computer program in the form of a computer-readable storage medium is described. The providing apparatus is for example a storage unit that stores the computer program and makes it available for retrieval. Alternatively or additionally, the providing apparatus is a network service, a computer system, a server system, in particular a distributed system, for example a cloud-based computer system or virtual computer system, which stores the computer program on a computer-readable storage medium and preferably provides it in the form of a data stream.

Provision takes place in the form of program data records describing program modules as a file, in particular a download file, or as a data stream, in particular a download data stream, of the computer program product. The computer program product is, for example, transferred to a computing environment using the providing apparatus, so that the method according to the invention can be executed in one or more computing entities of this computing environment.

### EMBODIMENTS OF THE INVENTION

Variants describing developments of the invention are explained below without limiting the basic concept of the invention.

According to one variant, the above-described aspects of the invention are determined by the fact that the vehicle is relatively localized taking into account the speed starting from a known location of the vehicle at a known time.

The localization method according to the invention is a relative localization method since, although the feature points are recognized by analyzing the images, they are not linked to a specific location on the route. The location known at a known time has preferably been ascertained by an absolute localization method. This has the advantage that the measurement accuracy for the starting point of the relative localization method is thus comparatively accurate. The above-mentioned applies equally to the accuracy of the relative localization in that the relative localization is comparatively accurate compared to known and biometric methods and the cumulative error can thus be kept small.

According to one variant, the above-described aspects of the invention are determined by the fact that the sensor is aligned with a capture direction at least substantially in the direction of travel.

Alignment in the direction of travel can be described in such a way that a capture direction (for example the optical axis of a lens of an image sensor, also called image axis) of the imaging sensor is substantially aligned in the direction of travel. Alignment substantially in the direction of travel means that an angle between the image axis and the direction of travel does not have to be zero. An angle of up to 5°, preferably up to 2°, between the capture direction and the direction of travel is likewise possible without impairing the functionality of the method. Advantageously, the smaller the angle, the more accurate the speed measurement. However, an angle of up to 5° can be accepted without the measurement error becoming too great. A further advantage is that interference from objects moving in the image area can be deliberately filtered out if these objects are not moving along the track.

According to one variant, the above-described aspects of the invention are determined by the fact that a selection of a characteristic image area is restricted to a track area depicted in the images in a respective image section.

Within the meaning of the invention, the track area should be understood to mean the track system itself, formed of the superstructure (including the rails, sleepers and measures for fastening the rails on the sleepers) and the substructure (including ballast or another base), and fixed elements of the route on the track system (route elements such as balises, switches, signals, overhead lines, etc.). Restricting the determination feature points to one image point and filtering the feature points improves the quality of the speed determination according to the invention and renders the ascertainment of the speed more robust and more accurate.

According to this embodiment of the invention, the area in which feature points are determined is limited to the track area ahead of the train when the sensor is aligned in the direction of travel. This excludes, as far as possible, the presence of other moving objects, such as other trains or people in the stop area in the relevant image section, since it is assumed that the area in front of the moving train is protected by the signaling system of the railroad system and is hence free of objects. Other moving objects would lead to incorrect speeds, since the result is the differential speed of the moving object and the train. In addition to excluding areas in which moving objects are to be expected, limitation to one image area also has the advantage that the amount of image data to be processed is reduced, and hence the computing speed of the method is higher.

According to one variant, the above-explained aspects of the invention are determined by the fact that object recognition is performed for elements of the track area to determine the image section.

Object recognition must be trained in a manner that is known per se. In particular, computer-aided artificial intelligence can be used for this purpose. In the context of the present invention, artificial intelligence (hereinafter also abbreviated to AI) should be understood in the narrower sense as computer-aided machine learning, (hereinafter also abbreviated to ML). This involves statistical learning of the parametrization of algorithms, preferably for very complex applications. ML enables the system to recognize and learn patterns and regularities in the captured process data based on previously input learning data. With the aid of suitable algorithms, ML can independently find solutions to any problems that occur. ML is divided into three fields-supervised learning, unsupervised learning and reinforcement learning, with more specific applications, for example regression and classification, structure recognition and prediction, data generation (sampling) or autonomous action.

In supervised learning, the system is trained by the relationship between input and the associated output of known data and in this way learns approximate functional relationships. This involves the availability of suitable and sufficient data, because, if the system is trained with unsuitable (e.g. non-representative) data, it learns incorrect functional relationships. In unsupervised learning, the system is likewise trained with sample data, but only with input data and without any connection to known output. It learns how data groups are to be formed and expanded, what is typical for the application in question and where deviations or anomalies occur. This allows applications to be described and error states to be detected. In reinforcement learning, the system learns through trial and error by proposing solutions to given problems and receives a positive or negative evaluation of this proposal via a feedback function. The AI system learns to execute corresponding functions according to a reward mechanism.

Object recognition advantageously enables the image section to be adapted in each case to the conditions of the route according to the existing recognized image elements. Alternatively, a simpler solution can also be implemented in which a fixed image section is defined. For example, a triangular image area based on the lower edge of the image with its apex at the vanishing point or exactly in the center of the image is suitable.

According to one variant, the above-explained aspects of the invention are determined by the fact that displacement vectors of the characteristic image area are in each case determined in successive images in order to assess the perspective displacement.

When the feature points have been determined in all evaluated images, the object is to compare them with one another in order to achieve an assignment of the feature points from image A to those from image B, etc. This object can, for example, be achieved using the FLANN (fast library of approximate nearest neighbors) algorithm. Hence, this in each case results in pairs of points that assign a point in image A to another point in image B etc. According to the invention, the next step is to determine the displacement vector between the two points of each pair of points.

The size of the displacement vector is a measure of the speed, which can be determined using the known time interval between the images. If the displacement vector has a value of 0, it can be concluded that the camera has not moved relative to the feature point between the times at which the images were recorded (i.e. the vehicle is stationary). If the vehicle is moving, the motion vectors have a value other than zero. The same also applies to an image axis vector that extends exactly in the viewing direction of the imaging sensor (more on this below).

According to one variant, the above-explained aspects of the invention are determined by the fact that the suitability of the displacement vectors for ascertaining the speed is checked by calculating the scalar product from the relevant displacement vector and an image axis vector.

The term “image axis” is used in a technical sense in connection with the central projection in the generated images. This refers to the straight line that is perpendicular to the image plane and simultaneously passes through the projecting lens. The image axis vector is created by determining it in the two successive images in the same way as the displacement vector and is hence dependent on the speed of the vehicle. The scalar product advantageously represents a measure of the suitability of the ascertained motion vector for determining the speed. The greater the scalar product, the more suitable the associated motion vector is for ascertaining the speed.

According to one variant, the above-described aspects of the invention are determined by the fact that the displacement vector and the image axis vector are normalized before the scalar product is calculated.

Hence, the scalar product between the normalized displacement vector and the normalized image axis vector of the sensor that recorded the images can then be determined. The vectors must be normalized before the scalar product is formed if the result is to be advantageously invariant with respect to the speed traveled. The scalar product describes the angle between the displacement vector and the viewing axis. Hence, it is also invariant with respect to the direction of travel of the train.

According to one variant, the above-described aspects of the invention are determined by the fact that a displacement vector is only used for speed determination if a computer-aided check reveals that the scalar product is above a predetermined threshold value or at least at the predetermined threshold value.

One advantage of this variant is that the scalar product is always between zero and one, regardless of the speed, due to the normalization of the displacement vector and the image axis vector. It is therefore possible for a threshold value to be defined that can be assessed independently of the speed. Without normalization, the threshold value must be specified in dependence on the speed.

If the scalar product is above the configured threshold value, it is ensured that the pair of points for determining the speed is substantially in the direction of view of the camera and thus in the direction of travel. The ascertained speed value is valid. If the scalar product is below a configured threshold value, the pair of points must be discarded because the movement of the points is not sufficiently in the direction of view of the camera and thus does not coincide with the direction of travel. It can be assumed that the points are located on an object with a main direction of travel that is not parallel to the rails.

As the train is rail-guided, only movements along the direction of view are possible and only these components are relevant and should be used to determine the speed. Effects such as curve radii or pairs of points that describe lateral movements (e.g. due to errors in the FLANN algorithm or because small objects, such as leaves or garbage, move on the track), are also taken into account in the configured threshold value.

The proposed test algorithm enables distortions of the speed measurement values caused by movements in the image (which do not occur in the direction of view) to be recognized in each measurement cycle. This further increases the quality of the speed because moving objects in the image can be detected and excluded by the filtering if their movement does not take place along the tracks, but at least at a configurable angle to the tracks. The invention is characterized by the fact that the filtering is independent of both the direction of travel and the speed traveled.

Other features which are considered as characteristic for the invention are set forth in the appended claims.

Although the invention is illustrated and described herein as embodied in a method for determining the speed of a track-guided vehicle traveling on a route, a vehicle, a computer program product and a computer-readable storage medium, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Further details of the invention are described below with reference to the drawing. Identical or corresponding drawing elements are in each case given the same reference symbols in the individual figures and are only explained more than once if there are differences between the individual figures.

The exemplary embodiments explained below are preferred embodiments of the invention. In the exemplary embodiments, the described components of the embodiments in each case represent individual variants of the invention, which are to be considered independently of one another and in each case also develop the invention independently of one another and are thus also to be regarded as part of the invention individually or in a combination other than that shown. Furthermore, the described components can also be combined with the above-described variants of the invention.

### BRIEF DESCRIPTION OF THE FIGURES

FIG. 1 is a schematic depiction of an exemplary embodiment of the apparatus according to the invention (track-guided vehicle on a route) with its interactions between the functional components being used;

FIG. 2 is an exemplary embodiment of a computing environment for the apparatus according to FIG. 1 as a block diagram of the individual functional components and the interfaces between them, wherein individual computing entities execute program modules which can in each case run in one or more of the computers shown by way of example and wherein the interfaces shown can accordingly be implemented at software level in a computer or at hardware level between different computers;

FIG. 3 and FIG. 4 are schematic depictions of example images recorded by the imaging sensor using the method according to the invention, in which a route with a track and objects or characteristic image areas in the vicinity of the route can be recognized in these images; and

FIG. 5 is a flowchart showing an exemplary embodiment of the method according to the invention, wherein the method steps shown can be implemented individually or in groups by program modules and wherein the computing entities and interfaces according to FIG. 2 are indicated by way of example.

### DETAILED DESCRIPTION OF THE INVENTION

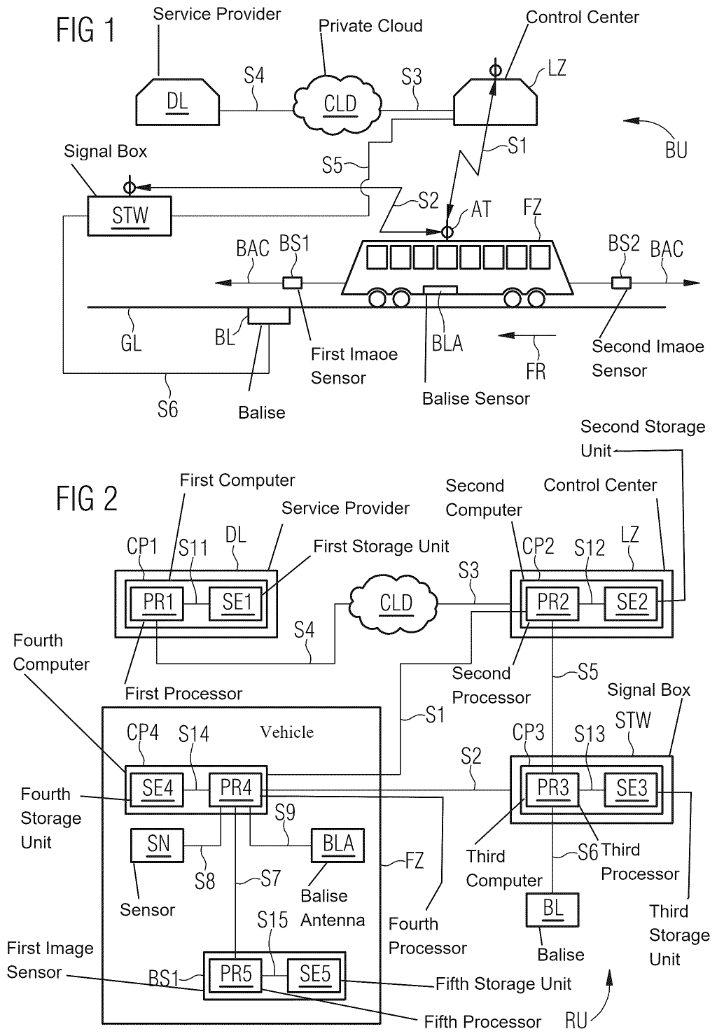

Referring now to the figures of the drawings in detail and first, particularly, to FIG. 1 thereof, there is seen a railroad environment BU in which the method according to the invention runs. Herein, a computing environment RU as depicted in FIG. 2 is used. FIG. 1 depicts a track-guided vehicle FZ traveling in a direction of travel FR on a track GL. A signal box STW, which actuates functional components of the railroad environment BU, such as for example a balise BL (in the case of a transparent data balise), is provided on the route formed by the track GL. This can be read by using a balise antenna BLA on the vehicle FZ. The vehicle FZ also has a first image sensor BS1 and a second image sensor BS2, wherein one is aligned with its image axis BAC in the direction of travel FR and the other is aligned with its image axis BAC opposite the direction of travel FR.

In addition, a control center LZ is provided in which, for example, compliance with a timetable can be monitored by vehicles FZ deployed in the railroad environment BU. The signal box STW, the control center LZ and the vehicle FZ are equipped with antennas AT that enable radio-based communication between the aforementioned units. In addition, a private cloud CLD is provided via which data can be exchanged, for example with a service provider DL that offers artificial intelligence in the form of computing services.

The computing environment RU in which the method according to the invention runs can be seen in FIG. 1 and FIG. 2. The computing entities and functional components which are used interact with one another via interfaces. The track-guided vehicle FZ and the control center LZ are connected to one another via a first interface S1. The vehicle FZ and the signal box STW are connected to one another via a second interface S2. The control center LZ and the cloud CLD are connected to one another via a third interface S3. The cloud CLD and the service provider DL are connected to one another via a fourth interface S4. The control center LZ and the signal box STW are connected to one another via a fifth interface S5. The signal box STW and the balise BL are connected to one another via a sixth interface S6.

FIG. 2 depicts the computer forming computing entities in each case in more detail. In a first computer CP1 in the service provider DL, a first processor PR1 is connected to a first storage unit SE1 via an eleventh interface S11. In a second computer CP2 in the control center LZ, a second processor PR2 is connected to a second storage unit SE2 via a twelfth interface S12. In a third computer CP3 in the signal box STW, a third processor PR3 is connected to a third storage unit SE3 via a 13th interface S13. In a fourth computer CP4 in the vehicle FZ, a fourth processor PR4 is connected to a fourth storage unit SE4 via a 14th interface S14. In the first image sensor BS1, a fifth processor PR5 is connected to a fifth storage unit SE5 via a 15th interface S15. The fourth processor PR4 and the fifth processor PR5 are connected to one another via a seventh interface S7. The fourth processor PR4 of the first image sensor BS1 and a sensor SN are connected to one another via an eighth interface S8 (even though the second image sensor BS2 is not depicted in FIG. 2, it could be connected to the fourth processor PR4 in a similar way). The sensor SN can be a positioning sensor with any operating principle. It could be a GPS sensor, an odometry sensor in the form of a tachometer or distance radar. The fourth processor PR4 and the balise antenna BLA are connected to one another via a ninth interface S9.

Although only computers, processors, memory units or interfaces are referred to in the context of this description of the invention, the information generally refers to all of the individually aforementioned computers, processors and other functional components, which, connected via the interfaces, contribute to the formation of the computing environment RU.

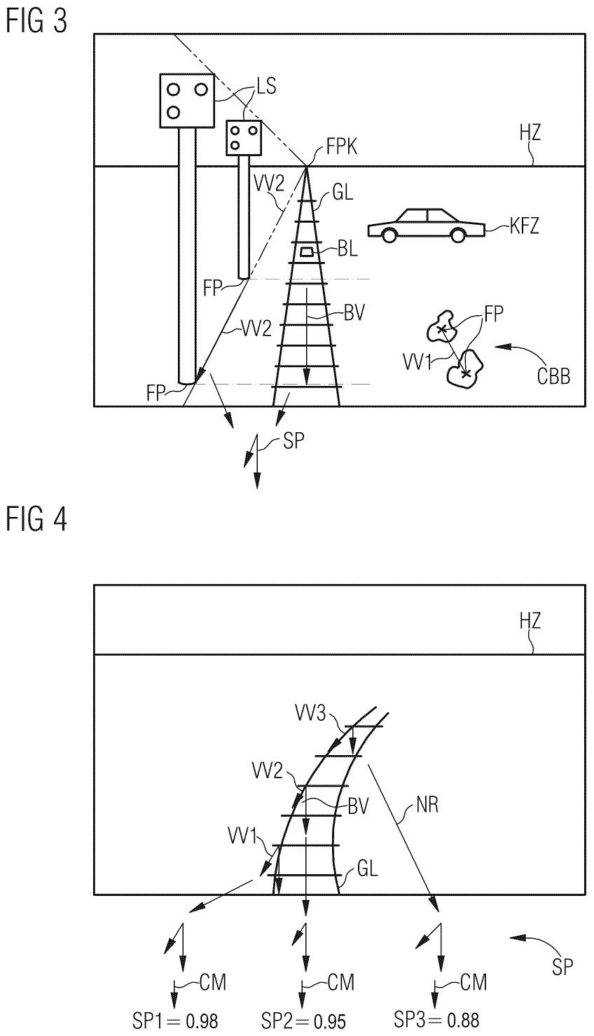

FIGS. 3 and 4 in each case depict by way of example one of two superimposed images recorded by the sensor SN facing in the direction of travel. Arrows indicate displacement vectors between pairs of feature points FP of the two images (hereinafter feature point pairs). These can only be visualized in the image because the feature points FP from both images are shown in a single figure. Of course, such visualization is not necessary to perform the method. The course of the vectors is calculated by comparing the relevant images. The vector of the viewing axis is depicted vertically downward as the viewing axis vector in order to graphically indicate the formation of the scalar products SP (in FIG. 4 a first scalar product SP1, a second scalar product SP2 and a third scalar product SP3) between the displacement vectors and the viewing axis.

FIG. 3 shows a schematic image in which a straight track leads to a vanishing point FPK on a horizon HZ. This simplifies the explanation of the method. However, as can be seen in FIG. 4, other courses of the track GL, for example in a curve, are suitable for performing the method under certain conditions. There are various objects on the track GL that can be recognized by image recognition and to which feature points FP can be assigned. For example, a light signal LS is depicted. The balise BL can also be used to generate feature points FP. However, a motor vehicle KFZ is unsuitable since it can also move and could therefore give rise to incorrect speed measurements. If this vehicle is recognized during object recognition, it is excluded from the formation of feature points.

Independently of object recognition, characteristic image areas CBB can also be used in the method. These can, for example, be recognized from a strong contrast with respect to adjacent image areas without necessarily being a specific object. These characteristic image areas CBB also “migrate” to the image edge in the successive images, so that they are suitable for defining feature points FP and, as depicted in FIG. 3, a first displacement vector VV1. Another feature point FP is formed by the base of the light signal LS, which is used to generate a second displacement vector VV2.

According to FIG. 4, the image is recorded while the vehicle FZ is cornering, which is why the track GL is curved in the image. In this example, the first displacement vector VV1 represents a feature point pair that has moved in accordance with the direction of travel. Here, the scalar product SP SP1=0.99 is significantly greater than a threshold value h=0.9. The second displacement vector VV2 lies on a curve. As a result, at 0.95, SP2 is smaller than SP1 but still larger than the threshold value and within the accepted range. Finally, an erroneous third displacement vector VV3 is shown in the further, and thus more distant, course of the curve. Here, at 0.88 SP3 is smaller than the threshold value h and therefore this feature point pair is rejected.

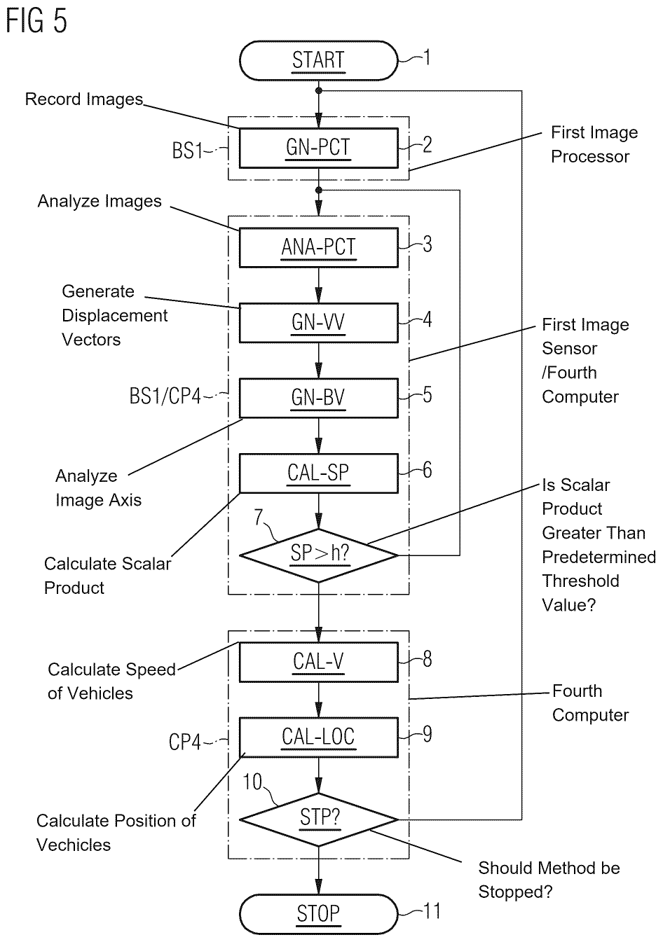

In the following, the method according to the invention is explained by way of example step-by-step, as depicted in the flowchart according to FIG. 5. FIG. 5 also indicates, by way of example, by using boxes, the functional components and computing entities according to FIGS. 1 and 2 which can perform the individual steps. Computer-aided steps take place in the processors (not shown in further detail). Reading and saving of data in the memory units is shown by way of example. In this case, where the interfaces according to FIGS. 1 and 2 are used, they are also marked in FIG. 5.

In a first step 1, the method is started (START for short).

In a second step 2, images are recorded (GN-PCT for short). The images are preferably recorded in the direction of travel FR from the section of route ahead of the moving vehicle FZ. A sequence of images is created all so that two successive images can be selected therefrom. These do not necessarily have to be directly behind one another in the sequence. Images can also be omitted.

In a third step 3, the images are analyzed (ANA-PCT for short). For this, at least two successive images must be available in which the same object or the same characteristic image area CBB can be recognized. Recognition of these image elements enables feature points FP to be defined.

In a fourth step 4, displacement vectors are generated based on the recognition of the feature points FP in the successive images (GN-VV for short). The displacement vectors extend from the inside of the image to the outer edge if the image axis (more precisely the associated image axis vector BV) was selected in the direction of travel FR. In a fifth step 5, the image axis is also analyzed in order to determine an image axis vector BV (GN-BV for short).

In a sixth step 6, the scalar product is then calculated from the previously calculated vectors, namely the displacement vector and the image axis vector BV (CAL-SP for short). This determines whether or not the calculated displacement vector is used for a speed calculation. In a seventh step 7, a query is namely made as to whether the scalar product SP is greater than a predetermined threshold value of, for example, 0.9 (SP>h? for short). Only if this is the case does the process continue with step eight. Otherwise, there is a recursion to repeat step 3.

In an eighth step 8, the speed of the vehicle FZ is calculated (CAL-V for short). This can then be used to localize the vehicle FZ. Other control tasks can also be performed (not depicted in FIG. 5). In a ninth step 9, the position of the vehicle FZ is calculated (CAL-LOC for short). This is relative localization based on the last reliably known absolute localization of the vehicle FZ. The relative localization is continued at least until absolute localization with comparatively higher accuracy is possible.

In a tenth step 10, a query is made as to whether the method should be stopped (STP? for short). As mentioned, this is the case when absolute localization with high accuracy is available. In this case, in an eleventh step 11, the method is stopped (STOP for short). If further relative localization values are to be generated, there is a recursion to the second step 2.

The following is a summary list of reference numerals and the corresponding structure used in the above description of the invention:
AT Antenna
BA Balise antenna
BAC Image axis
BL Balise
BS1 First image sensor
BS2 Second image sensor
BU Railroad environment
BV Image axis vector
CBB Characteristic image area
CLD Cloud
CP1 First computer
CP2 Second computer
CP3 Third computer
CP4 Fourth computer
DL Service provider
FP Feature point
FPK Vanishing point
FR Direction of travel
FZ Vehicle
GL Track
HZ Horizon
KFZ Motor vehicle
LS Light signal
LZ Control center
PR1 First processor
PR2 Second processor
PR3 Third processor
PR4 Fourth processor
PR5 Fifth processor
RT1 First routine
RT2 Second routine
RT3 Third routine
RU Computing environment
S1 First interface
S11 Eleventh interface
S12 Twelfth interface
S13 13th interface
S14 14th interface
S15 15th interface
S2 Second interface
S3 Third interface
S4 Fourth interface
S5 Fifth interface
S6 Sixth interface
S7 Seventh interface
S8 Eighth interface
S9 Ninth interface
SE1 First storage unit
SE2 Second storage unit
SE3 Third storage unit
SE4 Fourth storage unit
SE5 Fifth storage unit
SN Sensor
SP Scalar product
SP1 First scalar product
SP2 Second scalar product
SP3 Third scalar product
STW Signal box
VV1 First displacement vector
VV2 Second displacement vector
VV3 Third displacement vector

1. A method for determining the speed of a track-guided vehicle traveling on a route, the method comprising:
a) using an imaging sensor to capture and store a sequence of images of the route and its environment;
b) storing respective capture times of the images and assigning the respective capture times to the respective images;
c) recognizing characteristic image areas in the images;
d) selecting a number of stored images;
e) ascertaining a perspective displacement of at least one characteristic image area in the selected number of images arising due to movement of the vehicle;
f) converting the perspective displacement into a speed taking into account the capture times of the selected number of images;
i) determining displacement vectors of the characteristic image area in successive images to assess the perspective displacement; and
j) checking suitability of the displacement vectors for ascertaining the speed by calculating a scalar product from a relevant displacement vector and an image axis vector.

2. The method according to claim 1, which further comprises localizing the vehicle relatively by taking the speed into account starting from a location of the vehicle known at a known time.

3. The method according to claim 1, which further comprises aligning the sensor with a capture direction at least substantially in a direction of travel.

4. The method according to claim 1, which further comprises restricting a selection of a characteristic image area to a track area depicted in the images in a respective image section.

5. The method according to claim 4, which further comprises performing object recognition for elements of the track area to determine the respective image section.

6. The method according to claim 5, which further comprises normalizing the displacement vector and the image axis vector before calculating the scalar product.

7. The method according to claim 1, which further comprises only using a displacement vector for speed determination when a computer-aided check reveals that the scalar product is above a predetermined threshold value or at least at the predetermined threshold value.

8. A vehicle, comprising:
a facility for determining speed having the sensor according to claim 1 and a computing entity;
g) the sensor being constructed as an imaging sensor configured to perform at least step a); and
h) the at least one computing entity being part of a computing environment, the computing environment configured to perform at least steps b), c), d), e) and f).

9. A non-transitory computer program product, comprising program instructions to be executed by a computing environment for performing at least steps b), c), d), e) and f) according to claim 1.

10. A non-transitory computer-readable storage medium, comprising data stored as data records by the storage medium, the data records rendering the computer program product according to claim 8 executable.
